(19) United States
(12) Patent Application Publication
(10) Pub. No.: US 2026/0111020 A1
(43) Pub. Date: Apr. 23, 2026

(54) MONITORING CONTROL APPARATUS

(71) Applicant: MITSUBISHI ELECTRIC CORPORATION, Tokyo (JP)

(72) Inventor: Junya SHIMADA, Tokyo (JP)

(73) Assignee: MITSUBISHI ELECTRIC CORPORATION, Tokyo (JP)

(21) Appl. No.: 19/161,329

(22) PCT Filed: Apr. 19, 2023
(86) PCT No.: PCT/JP2023/015628

§ 371 Date: Sep. 2, 2025

(51) Int. Cl. G05B 23/02

(52) U.S. Cl. CPC G05B 23/0275; G05B 23/0248

(57) ABSTRACT

A monitoring control apparatus that can increase the accuracy of maintaining a monitored target includes: a relevance defining unit to define relevance between monitored items in a plurality of monitored items; a relevant model management DB to manage relevant models, using relevant monitored items of the monitored items; a monitoring data. management DB to manage monitoring data on the monitored items, a causal relationship calculator to calculate, when an error occurrence is detected from at least one of the monitored items, with which monitored item of the relevant models the error occurrence has a causal relationship, based on the relevant models managed by the relevant model management DB and the monitoring data managed by the monitoring data management database; and a cause identifier to identify a cause of the error occurrence, based on the monitored item with the causal relationship.

### TECHNICAL FIELD

The present disclosure relates to a monitoring control apparatus, and particularly to a monitoring control apparatus that monitors a plant such as a water treatment plant.

### BACKGROUND ART

Recent years have seen the development of mechanisms in monitoring systems of various plants including water treatment plants. When an error occurs, each of the mechanisms estimates a causal relationship of the error occurrence, and provides information to an operator in the plant.

For example, Patent Document 1 discloses a technology that defines relevance between tags of a field device and other field devices, such as an upstream and downstream positional relationship of piping disposed in a plant to define a possible causal relationship, and builds a causal model using processed data and a Bayesian network.

An analyzer converts the built causal model into a form corresponding to a quality management matrix (QMM), and presents the result.

### PRIOR ART DOCUMENT

### Patent Document

[Patent Document 1] Japanese Patent Application Laid-Open No. 2022-115643

### SUMMARY

### Problem to be Solved by the Invention

Patent Document 1 merely defines the relevance between tags of the field device and the other field devices such as the upstream and downstream positional relationship of piping to identify the causal relationship, and has a problem that limits a causal relationship that can be identified.

The present disclosure has been conceived to solve such a problem, and the object is to provide a monitoring control apparatus that can increase the accuracy of maintaining a monitored target without limiting a causal relationship between monitored items that can be identified.

### Means to Solve the Problem

A monitoring control apparatus according to the present disclosure is a monitoring control apparatus that monitors a plurality of monitored items that are monitored targets, the monitoring control apparatus including: a relevance defining unit to define relevance between monitored items in the plurality of monitored items; a relevant model management database to manage a plurality of relevant models, using relevant monitored items of the plurality of monitored items, the relevant monitored items being defined by the relevance defining unit; a monitoring data management database to manage monitoring data on the plurality of monitored items; a causal relationship calculator to calculate, when an error occurrence is detected from at least one of the plurality of monitored items, with which monitored item of the plurality of relevant models the error occurrence has a causal relationship, based on the plurality of relevant models managed by the relevant model management database and the monitoring data managed by the monitoring data management database; and a cause identifier to identify a cause of the error occurrence, based on the monitored item with the causal relationship which has been calculated by the causal relationship calculator, wherein the causal relationship calculator calculates the monitored item having the causal relationship with the error occurrence, based on a chronological change in the monitoring data before and after the error occurrence.

### Effects of the Invention

Since the monitoring control apparatus according to the present disclosure calculates with which monitored item of a plurality of relevant models an error occurrence has a causal relationship based on the plurality of relevant models and the monitoring data, and identifies a cause of the error occurrence based on the monitored item having the causal relationship, the monitoring control apparatus can increase the accuracy of maintaining a monitored target without limiting a causal relationship between monitored items that can be identified.

### BRIEF DESCRIPTION OF DRAWINGS

FIG. 1 is a block diagram illustrating a configuration of a monitoring control apparatus according to the present disclosure.

FIG. 2 is a diagram illustrating an example monitored item information management DB of the monitoring control apparatus according to the present disclosure.

FIG. 3 is a diagram illustrating an example monitoring data management DB of the monitoring control apparatus according to the present disclosure.

FIG. 4 is a diagram illustrating an example relevant model of monitored items defined by a monitored-items relevance defining unit of the monitoring control apparatus according to the present disclosure.

FIG. 5 is a diagram schematically illustrating a case where the monitoring control apparatus according to the present disclosure has detected an error occurrence.

FIG. 6 is a diagram indicating a current value and a last value of output values of a sensor in a monitoring data management DB of the monitoring control apparatus according to the present disclosure.

FIG. 7 is a diagram illustrating example calculation of a causal relationship with the error occurrence in the monitoring control apparatus according to Embodiment 1 of the present disclosure.

FIG. 8 is a diagram illustrating chronological changes in the monitoring data before and after the error occurrence in the monitoring data management DB of the monitoring control apparatus according to Embodiment 1 of the present disclosure.

FIG. 9 is a diagram illustrating identification of a cause of the error occurrence by a cause identifier in the monitoring control apparatus according to Embodiment 1 of the present disclosure.

FIG. 10 is a diagram illustrating chronological changes in the monitoring data before and after the error occurrence in the monitoring data management DB of the monitoring control apparatus according to Embodiment 1 of the present disclosure.

FIG. 11 is a diagram illustrating an example display on a display of the monitoring control apparatus according to Embodiment 1 of the present disclosure.

FIG. 12 is a diagram illustrating example calculation of a causal relationship by a causal relationship calculator in the monitoring control apparatus according to Embodiment 2 of the present disclosure.

FIG. 13 is a diagram illustrating chronological changes in the monitoring data before and after the error occurrence in the monitoring data management DB of the monitoring control apparatus according to Embodiment 2 the present disclosure.

FIG. 14 is a diagram illustrating example calculation of a causal relationship by the causal relationship calculator in the monitoring control apparatus according to Embodiment 3 of the present disclosure.

FIG. 15 is a diagram illustrating chronological changes in the monitoring data before and after the error occurrence in the monitoring data management DB of the monitoring control apparatus according to Embodiment 3 the present disclosure.

FIG. 16 is a diagram illustrating example calculation of a causal relationship by the causal relationship calculator in the monitoring control apparatus according to Embodiment 4 of the present disclosure.

FIG. 17 is a diagram illustrating chronological changes in the monitoring data before and after the error occurrence in the monitoring data management DB of the monitoring control apparatus according to Embodiment 4 the present disclosure.

FIG. 18 is a diagram illustrating example calculation of a causal relationship by the causal relationship calculator in the monitoring control apparatus according to Embodiment 5 of the present disclosure.

FIG. 19 is a diagram illustrating chronological changes in the monitoring data before and after the error occurrence in the monitoring data management DB of the monitoring control apparatus according to Embodiment 5 the present disclosure.

FIG. 20 is a diagram illustrating example calculation of a causal relationship by the causal relationship calculator in the monitoring control apparatus according to Embodiment 6 of the present disclosure.

FIG. 21 is a diagram illustrating chronological changes in the monitoring data before and after the error occurrence in the monitoring data management DB of the monitoring control apparatus according to Embodiment 6 the present disclosure.

FIG. 22 is a block diagram illustrating a configuration of a monitoring control apparatus according to a modification of the present disclosure.

FIG. 23 is a diagram illustrating a hardware configuration that implements the monitoring control apparatuses according to Embodiments 1 to 6 of the present disclosure.

FIG. 24 is a diagram illustrating a hardware configuration that implements the monitoring control apparatuses according to Embodiments 1 to 6 of the present disclosure.

FIG. 25 is a block diagram illustrating a configuration when the monitoring control apparatuses according to Embodiments 1 to 6 are provided in a server computer 300 that configures a cloud environment.

FIG. 26 is a block diagram illustrating a configuration of a monitoring control system according to Embodiment 7 of the present disclosure.

### DESCRIPTION OF EMBODIMENTS

### Embodiment 1

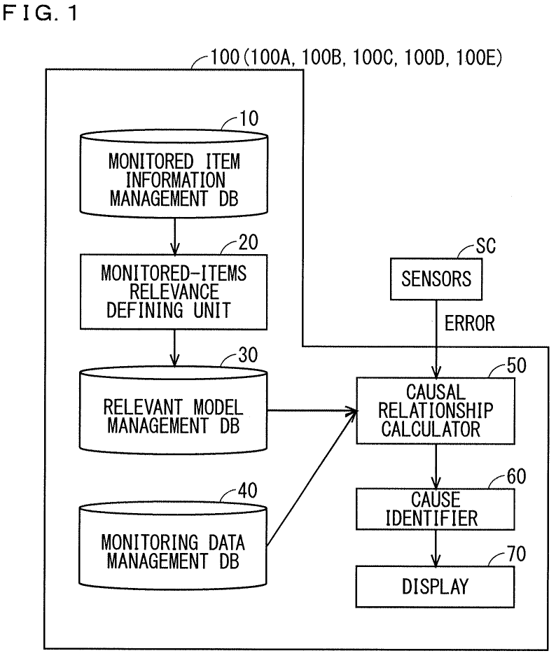

FIG. 1 is a block diagram illustrating a configuration of a monitoring control apparatus 100 according to Embodiment 1 of the present disclosure. As illustrated in FIG. 1, the monitoring control apparatus 100 includes a monitored item information management database (DB) 10, a monitored-items relevance defining unit 20, a relevant model management database (DB) 30, a monitoring data management database (DB) 40, a causal relationship calculator 50, a cause identifier 60, and a display 70.

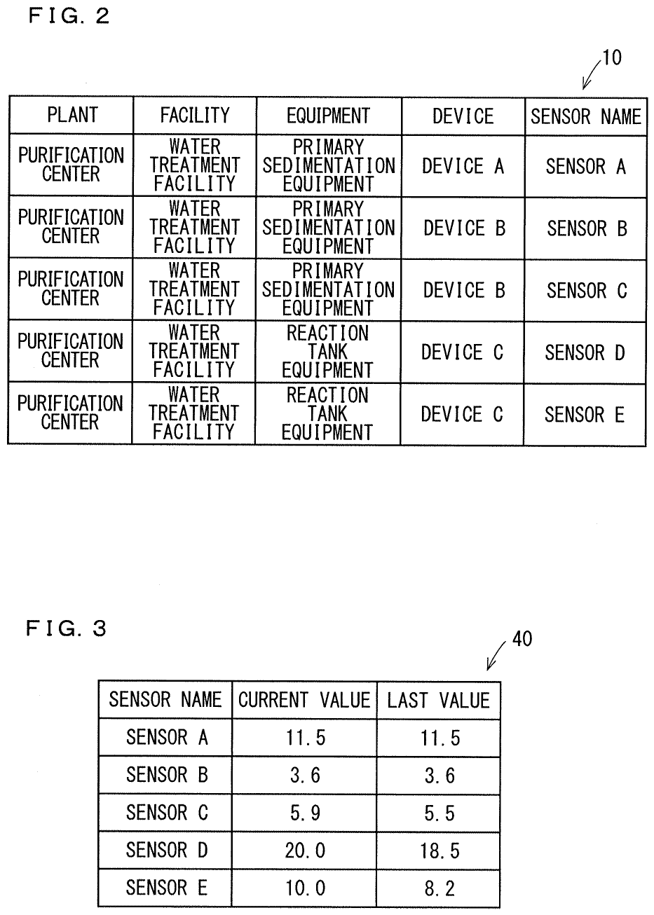

The monitored item information management DB 10 manages monitored item information such as equipment, devices, and sensor information to be managed by monitoring data. FIG. 2 is a diagram illustrating an example of the monitored item information management DB 10 in a table format. FIG. 2 indicates, as monitored items, plant, facility, equipment, device, and sensor name, and indicates “purification center” as a plant, a “water treatment facility” as a facility, “primary sedimentation equipment” and “reaction tank equipment” as equipment, “device A”, “device B”, and “device” as devices, and sensors a to E As sensor names.

The monitored-items relevance defining unit 20 defines relevance between monitored items. The relevance between monitored items refers to physical relevance such as equipment relevance indicating an equipment configuration of, for example, a facility, equipment, a device, and a sensor, wiring relevance between, for example, electric power lines in an electric power system, treatment procedure relevance in, for example, a purification plant and a sewage plant, or correlation relevance such as a correlation between experience values of a monitoring expert and a correlation calculated from a statistical analysis. The relevance between monitored items further includes system relevance between systems such as a monitoring control system and an equipment management system. The relevance between monitored items further includes relevance in information from a different sensor and information from a data source on an identical object such as a target object such as equipment, a device, a road, a bridge, or a tunnel, for example, inspection information, point group information, water level sensor information, vibration sensor information, camera image information, and weather information. This can expand the relevance between monitored items. Defining the relevance between monitored items means associating the monitored items with each other.

The relevant model management database DB 30 manages relevant monitored items defined by the monitored-items relevance defining unit 20 as a relevant model. In this management, a graph database (DB) is used, and the relevant model is managed as a tree structure. Specifically, the relevant model is managed using a Labeled Property Graph. Furthermore, the relevant model can be managed using a relational database (RDB). A specific example of the relevant model management DB 30 will be described later.

The monitoring data management DB 40 chronologically manages the monitoring data output by a monitoring device such as a sensor. The monitoring data is fed to the causal relationship calculator 50 together with the relevant model managed by the relevant model management DB 30. FIG. 3 is a diagram illustrating an example of the monitoring data management DB 40 in a table format. FIG. 3 indicates current values and last values of respective output values in the sensors A to E.

When a plurality of sensors SC disposed in respective parts of a plant detect error occurrences, the causal relationship calculator 50 calculates with which monitored item of which relevant model an error occurrence has a causal relationship, based on the relevant models and a chronological change in the monitoring data before and after the error occurrence.

The cause identifier 60 identifies a monitored item to be a cause of the error occurrence, based on the monitored item having the causal relationship which has been calculated by the causal relationship calculator 50.

The display 70 is a display that displays the monitored item having the causal relationship with the error occurrence which has been identified by the cause identifier 60, and the cause of the error occurrence,

Next, operations of the parts of the monitoring control apparatus 100 will be described using the relevant model management DB 30 when the Labeled Property Graph is used.

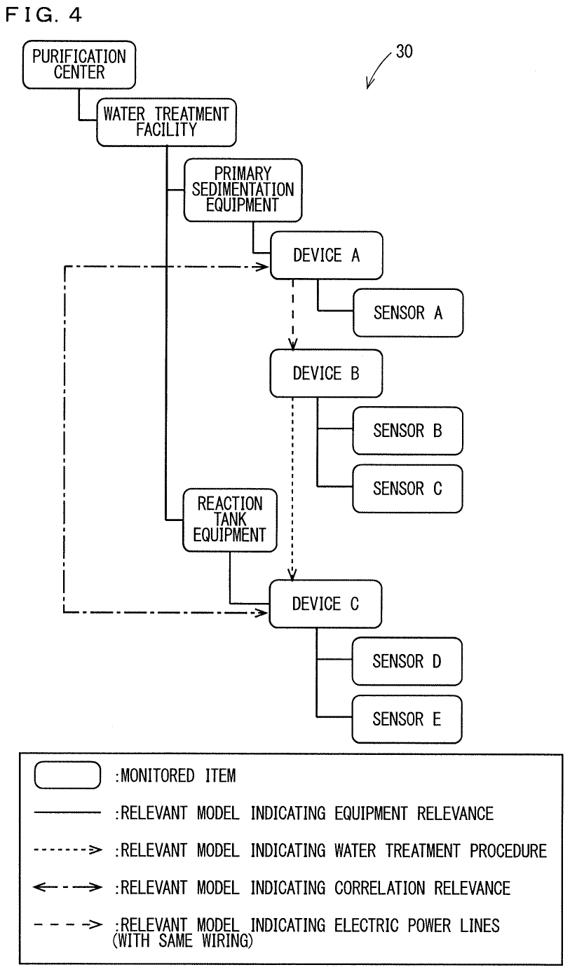

FIG. 4 illustrates an example relevant model of monitored items which has been defined by the monitored-items relevance defining unit 20, and illustrates an example of defining the relevant model, based on the monitored item information management DB 10 in FIG. 2.

In FIG. 4, a plurality of monitored items are developed into a tree diagram. A. purification center as a plant includes, as equipment of a water treatment facility, primary sedimentation equipment and reaction tank equipment. The primary sedimentation equipment includes the devices A and B, and the reaction tank equipment includes the device C. The device A includes the sensor A, the device B includes the sensors B and C, and the device C includes the sensors D and E.

Each of the monitored items is enclosed by a closing line, and a relevant model indicating equipment relevance is defined by connecting the monitored items by a solid line. A relevant model indicating a water treatment procedure is defined by a narrow-spaced dashed arrow which proceeds from the device B to the device C. A relevant model indicating correlation relevance is defined by a bidirectional single dot and dashed arrow between the device A and the device C. A relevant model indicating electric power lines with the same wiring is defined by a wide-spaced dashed arrow which proceeds from the device A to the device B.

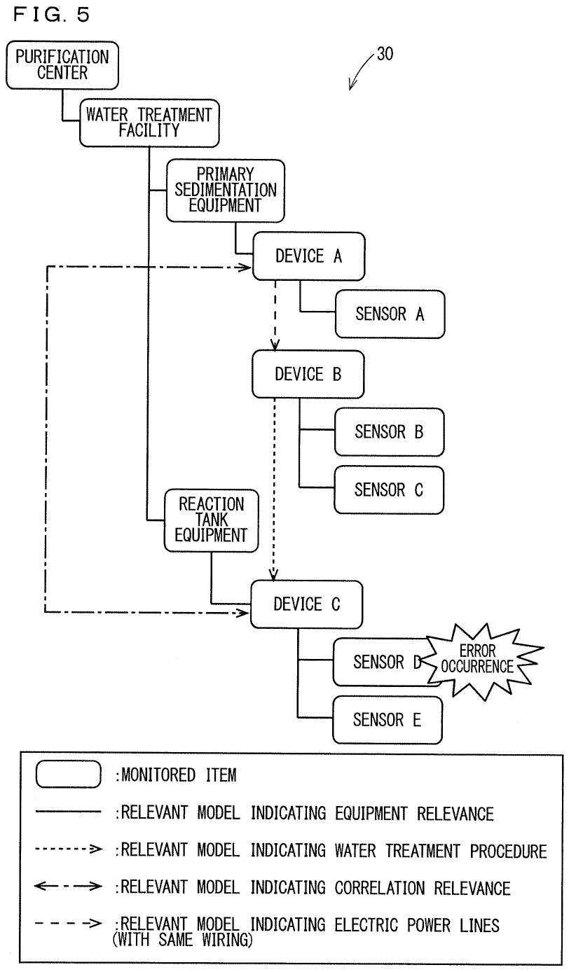

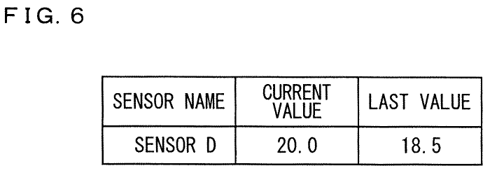

An example when a sensor SC (FIG. 1) in the plant has detected an error occurrence in the relevant model of the monitored items defined in such a manner will be described with reference to FIG. 5 schematically illustrates a case where the sensor D has detected an error occurrence. FIG. 6 indicates a current value and a last value of an output value of the sensor D in the monitoring data management DB 40. As illustrated in FIG. 6, the current value of the output value of the sensor D is 20.0, and its last value is 18.5.

When a difference between the current value and the last value of the output value of the sensor is larger, when the current value exceeds an existing threshold, or when the current value is determined to be an abnormal value from previous statistical results, an error occurrence is notified. Since the difference between the current value and the last value in the example of FIG. 6 is 1.5 which is large, the error occurrence was notified,

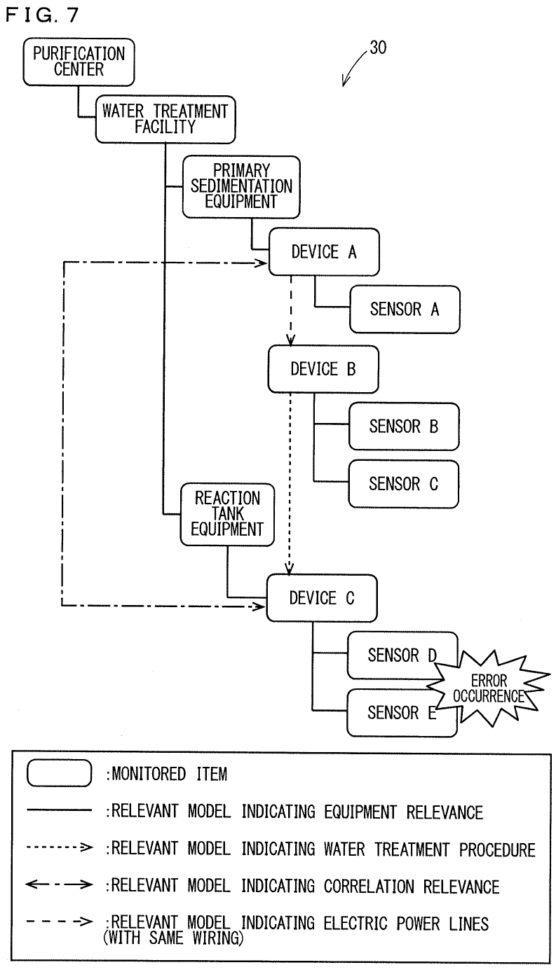

Next, example calculation of a causal relationship by the causal relationship calculator 50 will be described with reference to FIG. 7. While FIG. 5 schematically illustrates the case where the sensor D has detected the error occurrence, FIG. 7 schematically illustrates a probability that an error will also occur in the sensor E.

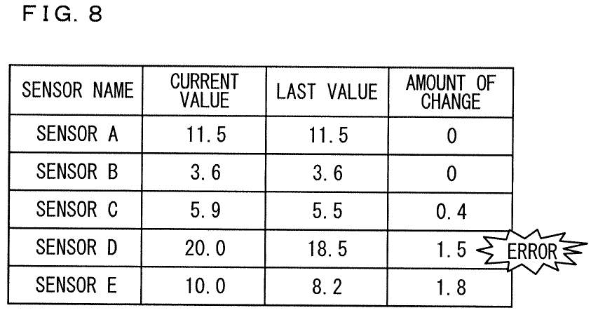

A sensor relevant to a sensor that has detected an error, that is, a sensor having a causal relationship with the error occurrence highly probably has a chronological change before and after the error occurrence, similarly to the sensor that has detected the error occurrence. FIG. 8 illustrates, as an amount of change, a calculation result of the chronological change in the monitoring data before and after the error occurrence from the current value and the last value of the output value of each of the sensors A to E in the monitoring data management DB 40. In FIG. 8, an amount of change in the output value of the sensor D from the last value is 1.5. Since the last value of the output value of the sensor E is 8.2 and the current value is 10.0, the amount of change from the last value is 1.8, which is larger than the amount of change in the sensor D. Thus, it is clear that the sensor E has a causal relationship with the error occurrence, similarly to the sensor D. Each of amounts of change of the sensors A to C from the last values is less than 0.5.

As such, calculation of the amount of change in each of the sensors from the last value allows calculation of a sensor with a chronological change similar to a chronological change in the sensor that has detected an error occurrence, as a sensor having a causal relationship with the error occurrence. The causal relationship can be calculated by calculating a chronological change in the monitoring data through a statistical method using a Euclidean distance. When using a Euclidean distance, a sensor that is the closest in two-point distance to the sensor that has detected the error occurrence is calculated as the sensor having the causal relationship with the error occurrence.

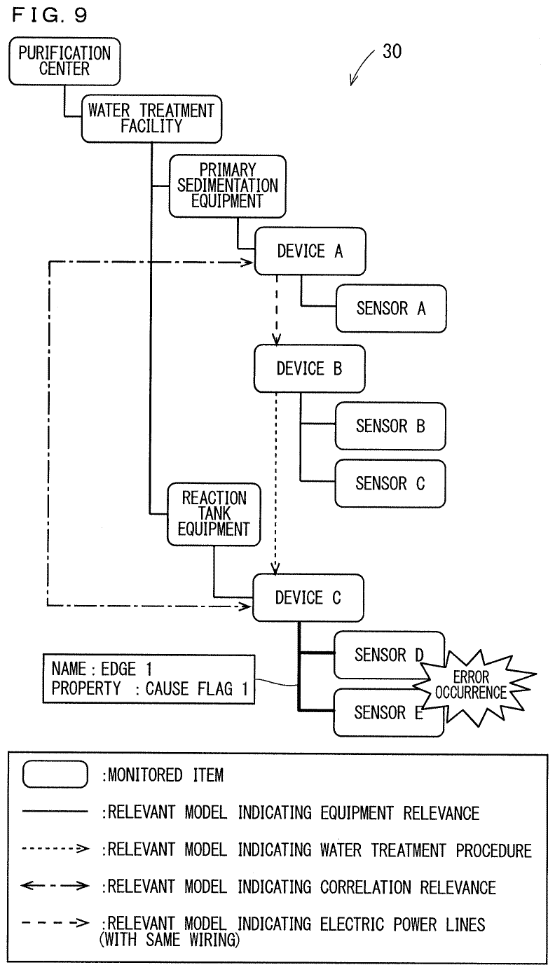

Next, identification of a cause of the error occurrence by the cause identifier 60 will be described with reference to FIG. 9. FIG. 9 illustrates an example of identifying, when there is a probability that an error will also occur in the sensor E, the sensor E as a sensor having the causal relationship with the error occurrence, similarly to the sensor D that has detected the error occurrence.

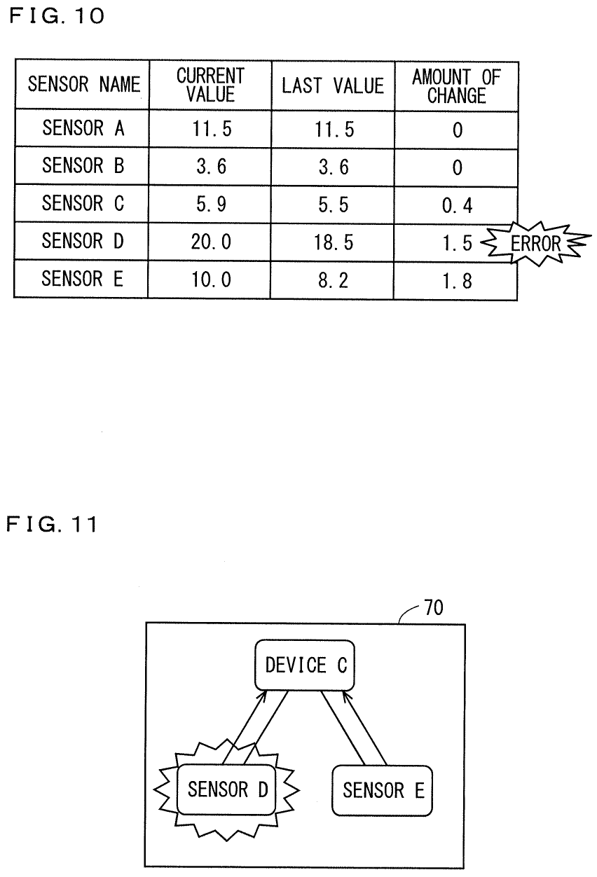

FIG. 10 illustrates, as an amount of change, a calculation result of the chronological change in the monitoring data before and after the error occurrence from the current value and the last value of the output value of each of the sensors A to E in the monitoring data management DB 40. In FIG. 10, an amount of change in the output value of the sensor D from the last value is 1.5, and an amount of change in the output value of the sensor E from the last value is 1.8. Thus, both of the amounts of change are higher than 0.5.

When a sensor having a causal relationship with the sensor that has detected the error occurrence is identified according to a magnitude of the amount of change, the sensor can be identified according to whether the amount of change exceeds a threshold. Assuming that the threshold of the amount of change is, for example, 0.5, the amount of change in the sensor E exceeds the threshold of 0.5. Since the relevant model indicating the equipment relevance shows that the sensor D and the sensor E are sensors relevant to the device C herein, the sensor E is identified as having the causal relationship with the error occurrence, similarly to the sensor D.

Furthermore, the sensor D and the sensor E are connected to the device C by a common solid line, and the device C is identified as a cause for the detection of the error occurrence by the sensor D. Here, the solid line that connects the sensor D and the sensor E to the device C is an edge in the Labeled Property Graph. A name can be defined for the edge. In FIG. 9, “EDGE 1” is labeled as a name of the edge, and “CAUSE FLAG 1” is labeled as a property (an attribute). Here, EDGE 1 is a name for defining “equipment relevance”.

Thus, the cause identifier 60 identifies that the sensor D and the sensor E have a causal relationship with an error occurrence due to the detection of the error occurrence by the sensor D. This can lead to identification of the device C as a cause of the error occurrence. This result is displayed on the display 70, and is presented to the user of the monitoring control apparatus 100.

FIG. 11 illustrates an example display on the display 70. In FIG. 11, detection of the error occurrence by the sensor D is luminously displayed, a causal relationship with the error occurrence is displayed by connection of the sensor D and the sensor E to the device C by solid lines, and arrows from the sensor D and the sensor E to the device C indicate that the device C is a cause of the error occurrence.

As described above, the monitoring control apparatus 100 according to Embodiment 1 defines relevance between monitored items such as the devices and the sensors which belong to a unit smaller than that of the constituent elements of the equipment and are associated with the equipment, so that a causal relationship between the monitored items and an error occurrence can be identified and a device that causes the error occurrence can be identified. This can reduce the cost for maintaining a plant more than that of a method of replacing all the relevant devices without finding out a cause of an error occurrence.

Furthermore, defining system relevance between systems such as a monitoring control system and an equipment management system allows monitoring control between the systems and monitoring control over a whole plant.

Furthermore, calculation of an amount of change in each of the sensors from the last value allows identification of a sensor with a chronological change similar to a chronological change in the sensor that has detected an error occurrence, as a sensor having a causal relationship with the error occurrence. Thus, the accuracy of identifying a device causing the error occurrence can be increased,

### Embodiment 2

Next, a monitoring control apparatus 100A according to Embodiment 2 of the present disclosure will be described. A block diagram illustrating a configuration of the monitoring control apparatus 100A is identical to that of the monitoring control apparatus 100 according to Embodiment 1 FIG. 1. In the monitoring control apparatus 100A according to Embodiment 2, processes in the causal relationship calculator 50 and the cause identifier 60 are different from those of the monitoring control apparatus 100.

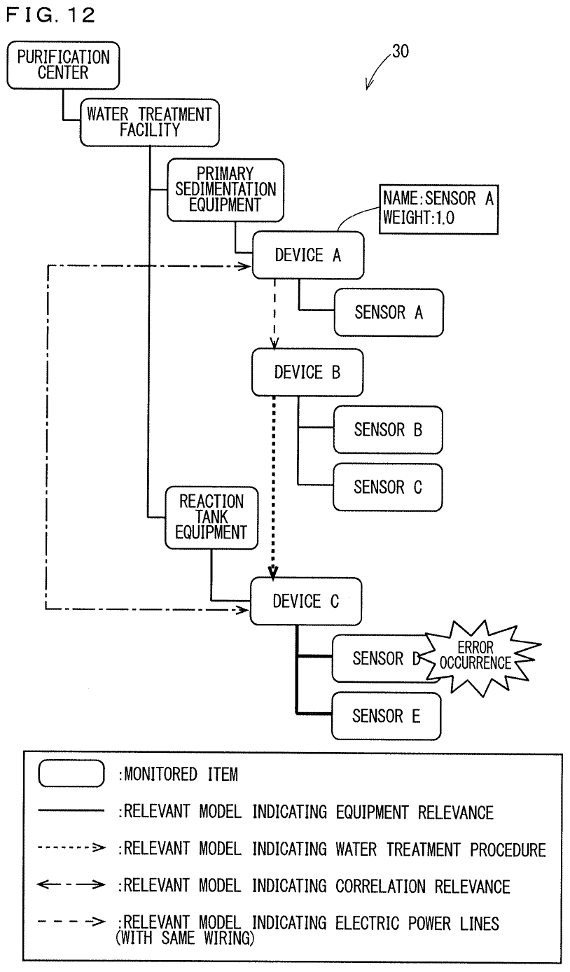

Example calculation of a causal relationship by the causal relationship calculator 50 in the monitoring control apparatus 100A will be described with reference to FIG. 12. FIG. 12 schematically illustrates a case where the sensor D has detected an error occurrence. FIG, 13 illustrates weights assigned to the sensors A to E as well as the calculation result of the chronological change in the monitoring data before and after the error occurrence from the current value and the last value of the output value of each of the sensors A to E in the monitoring data management DB 40 as the amount of change.

In other words, when a relevant model having a higher causal relationship with an error occurrence among the relevant models defined by the monitored-items relevance defining unit 20 is known in advance, the causal relationship calculator 50 assigns a weight to the relevant model. Here, the monitored items such as the device A are nodes in the Labeled Property Graph, and names of sensors with higher causal relationships can be defined for the nodes. In FIG. 12, the sensor A is defined as a sensor having a higher causal relationship with the device A, and a weight 1.0 of the sensor A is labeled as a property of the device A. Similarly, names of sensors with higher causal relationships are defined for the device B and the device C, and weights of the respective sensors are labeled. Here, a weight is set as a value to be multiplied by, for example, a current value. When the weight is 2.0, the current value is multiplied by 2.0.

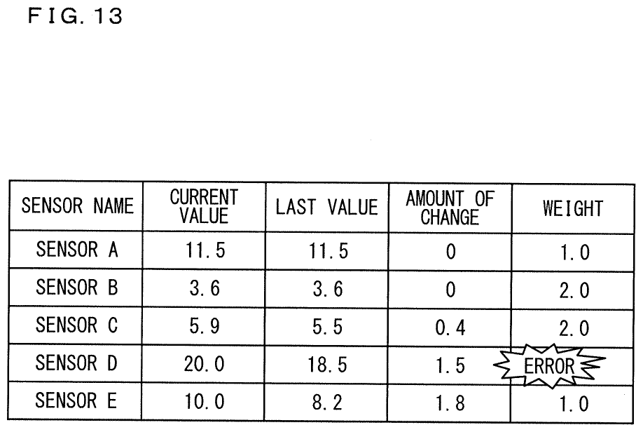

FIG. 13 indicates weights assigned to the sensors A to E, and each of the weights of the sensors B and C is 2.0. In FIG. 13, an amount of change in the output value of the sensor D from the last value is 1.5, and an amount of change in the output value of the sensor E from the last value is 1.8. Thus, both of the amounts of change are higher than 0.5.

Assuming that the threshold of the amount of change is 0.5, the amount of change in each of the sensors D and E exceeds the threshold of 0.5. Since the relevant model indicating the equipment relevance shows that the sensor D and the sensor E are sensors relevant to the device C herein, the sensor D and the sensor E are identified as having the causal relationship with the error occurrence.

Since the device B is known as having a higher causal relationship with the sensors B and C in advance and each of the weights of the sensors B and C is 2.0, the current value is multiplied by 2.0. The amount of change in the output value from the last value exceeds the threshold of 0.5. Thus, the sensors B and C are identified as having the causal relationship with the error occurrence.

Furthermore, since the relevant model indicating the water treatment procedure shows that the devices B and C are of the relevant model on the water treatment procedure and it is clear that the device B also causes the error occurrence, the device B and the device C can be identified as causing the error occurrence.

As described above, since the monitoring control apparatus 100A according to Embodiment 2 identifies a device causing an error occurrence, using not only the relevant model indicating the equipment relevance which is defined by physical connections between the equipment and the devices but also the relevant models defined by procedures such as the water treatment procedure, the monitoring control apparatus 100A can identify a cause of an error occurrence in a device in an indirect relationship. Thus, a cause of an error occurrence can be obtained from a wider range, and the accuracy of maintaining a plant can be increased.

When a relevant model having a higher causal relationship with an error occurrence is known in advance, a weight is assigned to the relevant model. Thus, the relevant model having the higher causal relationship with the error occurrence can be reliably identified.

### Embodiment 3

Next, a monitoring control apparatus 100B according to Embodiment 3 of the present disclosure will be described. A block diagram illustrating a configuration of the monitoring control apparatus 100B is identical to that of the monitoring control apparatus 100 according to Embodiment 1 FIG. 1. In the monitoring control apparatus 100B according to Embodiment 3, processes in the causal relationship calculator 50 and the cause identifier 60 are different from those of the monitoring control apparatus 100.

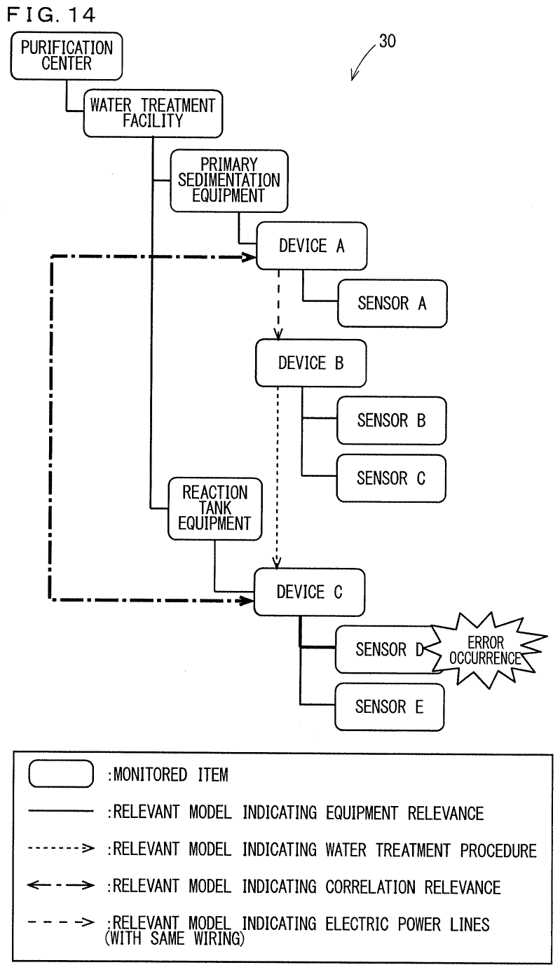

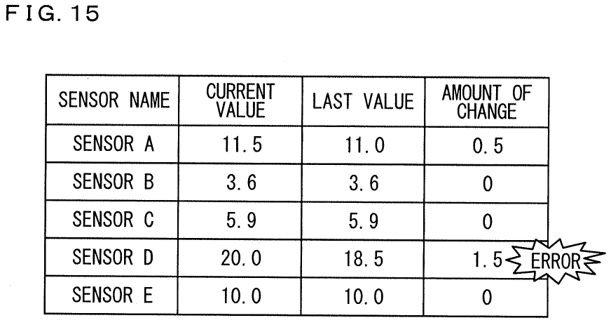

Example calculation of a causal relationship by the causal relationship calculator 50 in the monitoring control apparatus 100B will be described with reference to FIG. 14. FIG. 14 schematically illustrates a case where the sensor D has detected an error occurrence. FIG. 15 illustrates, as an amount of change, a calculation result of the chronological change in the monitoring data before and after the error occurrence from the current value and the last value of the output value of each of the sensors A to E in the monitoring data management DB 40. In FIG. 15, an amount of change in the output value of the sensor D from the last value is 1.5. Since the last value of the output value of the sensor A is 11.0 and the current value is 11.5, the amount of change from the last value is 0.5. The amount of change in each of the sensors B, C, and E from the last value is 0.

Assuming that the threshold of the amount of change is 0.5, the amount of change in each of the sensors A and D exceeds the threshold of 0.5. Since the relevant model indicating the equipment relevance shows that the sensor A is a sensor relevant to the device A and the sensor D is a sensor relevant to the device C, and the amount of change in the sensor A exceeds the threshold of 0.5 herein, it is clear that the sensor A has a causal relationship with the error occurrence. Furthermore, since the amount of change in the sensor D exceeds the threshold of 0.5, it is clear that the sensor D has a causal relationship with the error occurrence.

Since the relevant model indicating the correlation relevance shows that the device C is correlated with the device A, the device A can be identified as a cause of the error occurrence detected by the sensor D.

As described above, since the monitoring control apparatus 100B according to Embodiment 3 identifies a device that causes an error occurrence using not only the relevant model indicating the equipment relevance which is defined by physical connections between the equipment and devices but also the relevant model indicating the correlation relevance, the monitoring control apparatus 100B can identify a cause of the error occurrence in consideration of the correlation between experience values of a monitoring expert and a correlation calculated from a statistical analysis. Thus, the monitoring control apparatus 100B can identify a cause of an error occurrence that cannot be identified using other relevant models.

### Embodiment 4

Next, a monitoring control apparatus 100C according to Embodiment 4 of the present disclosure will be described. A block diagram illustrating a configuration of the monitoring control apparatus 100C is identical to that of the monitoring control apparatus 100 according to Embodiment 1 FIG. 1. In the monitoring control apparatus 100C according to Embodiment 4, processes in the causal relationship calculator 50 and the cause identifier 60 are different from those of the monitoring control apparatus 100.

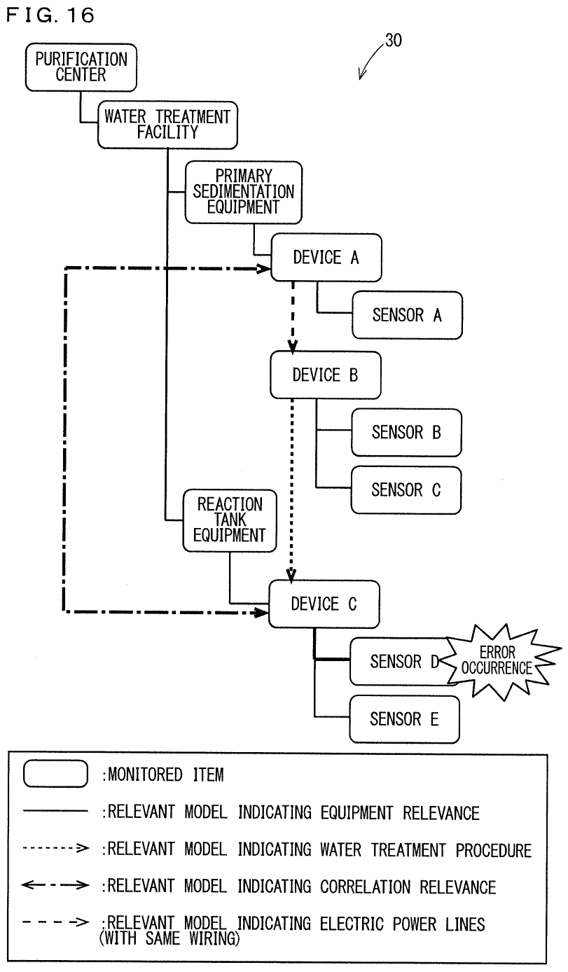

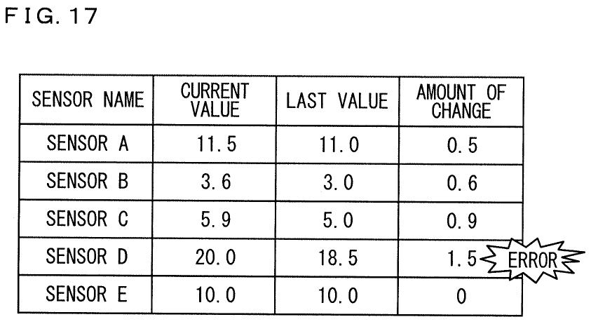

Example calculation of a causal relationship by the causal relationship calculator 50 in the monitoring control apparatus 100C will be described with reference to FIG. 16. FIG. 16 schematically illustrates a case where the sensor D has detected an error occurrence. FIG. 17 illustrates, as an amount of change, a calculation result of the chronological change in the monitoring data before and after the error occurrence from the current value and the last value of the output value of each of the sensors A to E in the monitoring data management DB 40. In FIG. 17, an amount of change in the output value of the sensor D from the last value is 1.5. Since the last value of the output value of the sensor A is 11.0 and the current value is 11.5, the amount of change from the last value is 0.5. Since the last value of the output value of the sensor B is 3.0 and the current value is 3.6, the amount of change from the last value is 0.6. Since the last value of the output value of the sensor C is 5.0 and the current value is 5.9, the amount of change from the last value is 0.9. The amount of change in the sensor E from the last value is 0.

Assuming that the threshold of the amount of change is 0.5, since the amount of change in each of the sensors A, B, C, and D exceeds the threshold of 0.5, it is clear that the sensors A, B, C, and D have a causal relationship with the error occurrence. Here, the relevant model indicating the equipment relevance shows that the sensor D is a sensor relevant to the device C, and the relevant model indicating the correlation relationship shows that the device C is correlated with the device A. Since the relevant model indicating electric power lines shows that the device A is a device relevant to the device B, the device A can be identified as a cause of the error occurrence detected by the sensor D.

As described above, the monitoring control apparatus 100C according to Embodiment 4 can identify a device that causes an error occurrence, using a combination of the relevant model indicating the equipment relevance which is defined by physical connections between the equipment and the devices, the relevant model indicating the correlation relationship, and the relevant model indicating electric power lines. Thus, the accuracy of identifying a cause of an error occurrence can be increased, and the accuracy of maintaining a plant can be increased.

### Embodiment 5

Next, a monitoring control apparatus 100D according to Embodiment S of the present disclosure will be described. A block diagram illustrating a configuration of the monitoring control apparatus 100D is identical to that of the monitoring control apparatus 100 according to Embodiment 1 FIG. 1. In the monitoring control apparatus 100D according to Embodiment 5, processes in the causal relationship calculator 50 and the cause identifier 60 are different from those of the monitoring control apparatus 100.

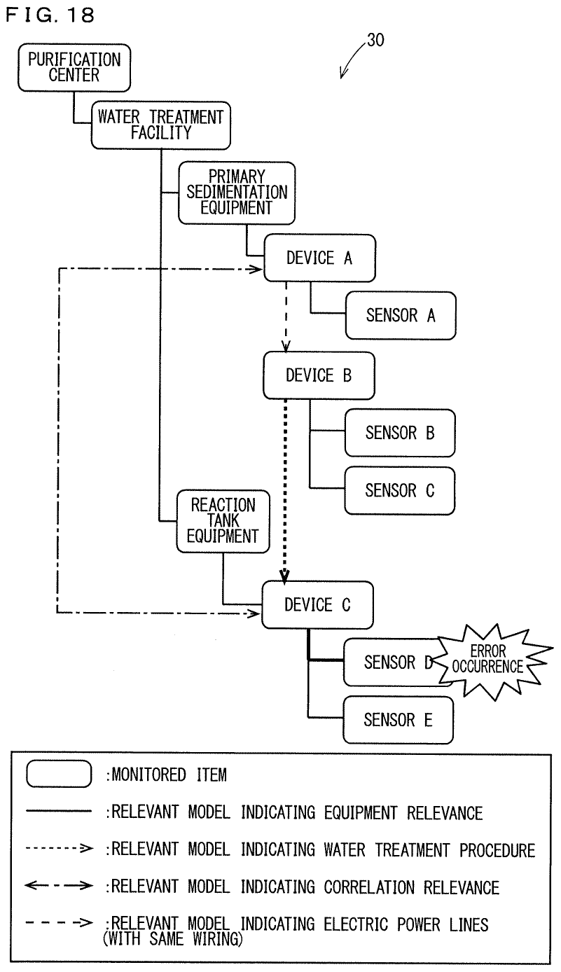

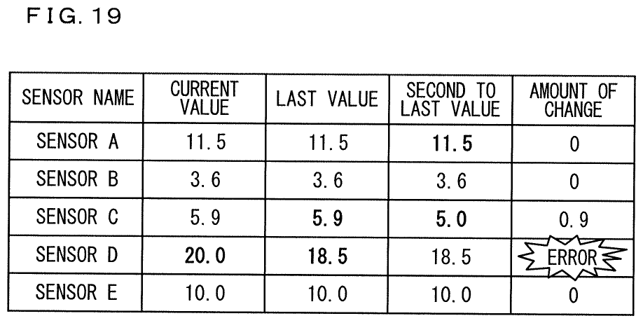

Example calculation of a causal relationship by the causal relationship calculator 50 in the monitoring control apparatus 100D will be described with reference to FIG. 18. FIG. 18 schematically illustrates a case where the sensor D has detected an error occurrence. FIG. 19 illustrates, as an amount of change, a calculation result of the chronological change in the monitoring data based on the current value, the last value, and the second to last value of the output value of each of the sensors A to E in the monitoring data management DB 40, In FIG. 19, the amount of change is a value calculated at a timing with a chronological change, the last value of the output value of the sensor C is 5.9, its second to last value is 5.0, and the current value is 5.9. Thus, FIG. 19 shows that a chronological change occurs between the last time and its second to last time. Meanwhile, the last value of the output value of the sensor D is 18.5, its second to last value is 18.5, and the current value is 20.0. Thus, FIG. 19 shows that a chronological change occurs between the current time and the last time.

These results show that the sensors C and D have a causal relationship with the error occurrence. Furthermore, it is possible to determine that a chronological change in the device B preceded the time of the error occurrence in the device C. Here, the relevant model indicating the equipment relevance shows that the sensor D is a sensor relevant to the device C. Furthermore, the relevant model indicating the water treatment procedure shows that the devices B and Care of the relevant model on the water treatment procedure, and the chronological change in the monitoring data of the sensor C precedes the chronological change in the monitoring data of the sensor D. Thus, it is possible to identify the device B as a cause of the error occurrence detected by the sensor D.

As described above, the monitoring control apparatus 100D according to Embodiment 5 can identify a device that causes an error occurrence in consideration of the timing with a chronological change in the monitoring data as well as using the relevant model indicating the equipment relevance which is defined by physical connections between the equipment and the devices, and the relevant model indicating the water treatment procedure. Thus, the accuracy of identifying a cause of an error occurrence can be increased, and the accuracy of maintaining a plant can be increased.

### Embodiment 6

Next, a monitoring control apparatus 100E according to Embodiment 6 of the present disclosure will be described. A block diagram illustrating a configuration of the monitoring control apparatus 100E is identical to that of the monitoring control apparatus 100 according to Embodiment 1 FIG. 1. In the monitoring control apparatus 100E according to Embodiment 6, processes in the causal relationship calculator 50 and the cause identifier 60 are different from those of the monitoring control apparatus 100.

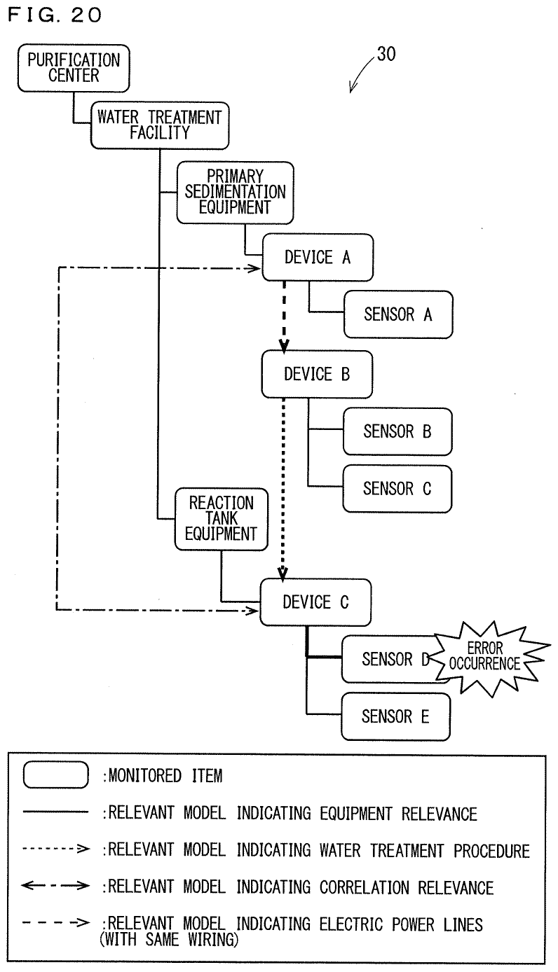

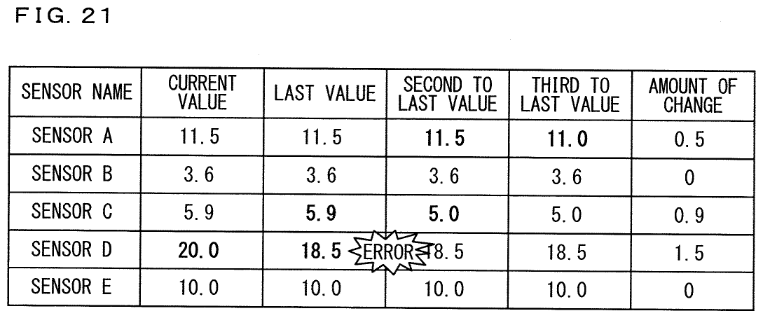

Example calculation of a causal relationship by the causal relationship calculator 50 in the monitoring control apparatus 100E will be described with reference to FIG. 20. FIG. 20 schematically illustrates a case where the sensor D has detected an error occurrence. FIG. 21 illustrates, as an amount of change, a calculation result of the chronological change in the monitoring data based on the current value, the last value, the second to last value, and the third to last value of the output value of each of the sensors A to E in the monitoring data management DB 40. In FIG. 21, the amount of change is a value calculated at a timing with a chronological change, each of the current value, the last value, and the second to last value of the output value of the sensor A is 11.5 and its third to last value is 11.0. Thus, FIG. 21 shows that a chronological change occurs between the second to last time and its third to last time. Meanwhile, each of the current value and the last value of the sensor C is 5.9, and each of the second to last value and the third to last value is 5.0. Thus, FIG. 21 shows that a chronological change occurs between the last time and the second to last time. Meanwhile, each of the last value, the second to last value, and the third to last value of the output value of the sensor D is 18.5 and its current value is 20.0. Thus, FIG. 21 shows that a chronological change occurs between the current time and the last time.

These results show that the sensors C and D have a causal relationship with the error occurrence. Furthermore, it is possible to determine that a chronological change in the device B preceded the time of the error in the device C and a chronological change in the device A further precedes the time. Here, the relevant model indicating the equipment relevance shows that the sensor D is a sensor relevant to the device C. Furthermore, the relevant model indicating the water treatment procedure shows that the devices B and C are of the relevant model on the water treatment procedure, and the relevant model indicating electric power lines shows that the device A is a device relevant to the device B. Furthermore, the chronological change in the monitoring data of the sensor C precedes the chronological change in the monitoring data of the sensor D, and the chronological change in the monitoring data of the sensor A precedes the chronological change in the monitoring data of the sensor C. Thus, it is possible to identify the devices B and A as causes of the error occurrence detected by the sensor D.

As described above, the monitoring control apparatus 100E according to Embodiment 6 can identify devices that cause an error occurrence in consideration of the timing with chronological changes in the monitoring data as well as using a combination of the relevant model indicating the equipment relevance which is defined by physical connections between the equipment and the devices, the relevant model indicating the water treatment procedure, and the relevant model indicating electric power lines. Thus, the accuracy of identifying a cause of an error occurrence can be increased, and the accuracy of maintaining a plant can be increased.

### Modification

The correlation relevance such as a correlation between experience values of a monitoring expert and a correlation calculated from a statistical analysis is described as the relevance between monitored items which is defined by the monitored-items relevance defining unit 20 in the monitoring control apparatuses 100 to 100E according to Embodiments 1 to 6. When these are defined, the experience values of the monitoring expert and statistical values can be handled as input information, relevance on the input information can be calculated by machine learning through artificial intelligence (AI), and the calculation results can be fed to the monitored-items relevance defining unit 20.

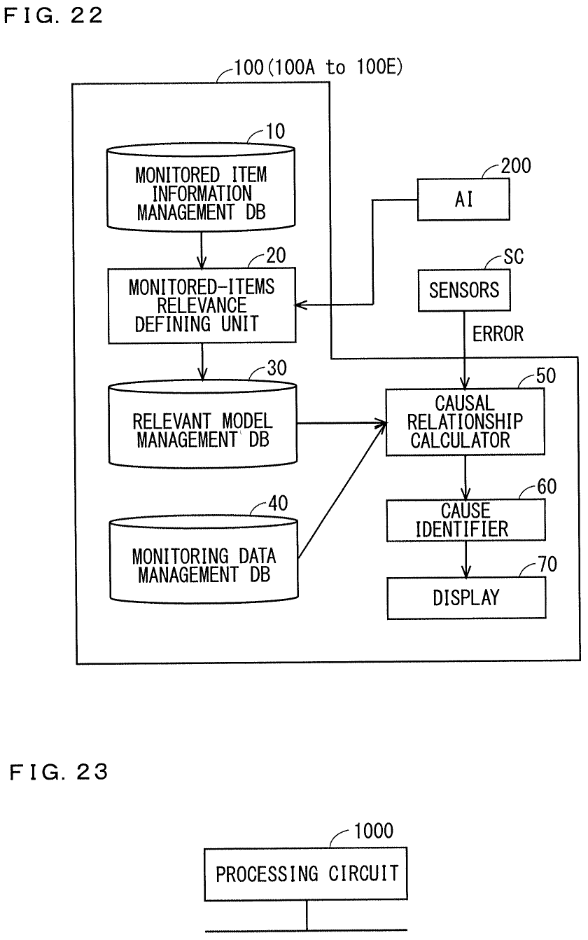

FIG. 22 illustrates the monitoring control apparatuses 100 to 100E in which information on the relevance between monitored items which has been calculated by an AI 200 is fed to the monitored-items relevance defining unit 20.

Since employing such a configuration can define correlation relevance between the monitored items from vague information such as the experience values of the monitoring expert, the processes in the monitored-items relevance defining unit 20 can be simplified.

### Hardware Configuration

Each of the constituent elements of the monitoring control apparatuses 100 to 100E according to Embodiments 1 to 6 described above can be configured using a computer, and is implemented by causing the computer to execute a program. In other words, the monitoring control apparatuses 100 to 100E are implemented by, for example, a processing circuit 1000 illustrated in FIG. 23. A processor such as a central processing unit (CPU) or a digital signal processor (DSP) is applied to the processing circuit 1000. The processing circuit 1000 causes the program stored in a storage to implement functions of each of the units.

The processing circuit 1000 may be dedicated hardware. When the processing circuit 1000 is dedicated hardware, the processing circuit 1000 is, for example, a single circuit, a composite circuit, a programmed processor, a parallel-programmed processor, an application-specific integrated circuit (ASIC), a field-programmable gate array (FPGA), or any combination of these.

Each function of the constituent elements of the monitoring control apparatuses 100 to 100E may be implemented by a separate processing circuit, or the functions may be collectively implemented by a single processing circuit.

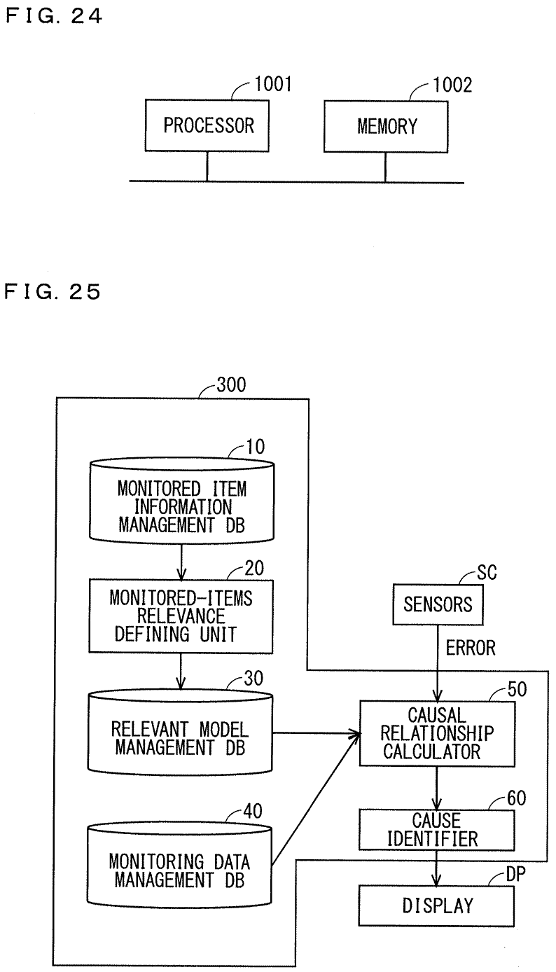

FIG. 24 illustrates a hardware configuration when the processing circuit 1000 is configured using a processor. In this case, the functions of the units of the monitoring control apparatuses 100 to 100E are implemented by any combinations with software, etc., (software, firmware, or the software and the firmware). The software, etc., is described as a program, and stored in a memory 1002. A processor 1001 functioning as the processing circuit 1000 implements the functions of each of the units by reading and executing a program stored in the memory 1002 (a storage). In other words, this program causes a computer to execute procedures and methods of operations of the constituent elements of the monitoring control apparatuses 100 to 100E.

Here, examples of the memory 1002 may include non-volatile or volatile semiconductor memories such as a RAM, a ROM, a flash memory, an erasable programmable read-only memory (EPROM), an electrically erasable programmable read-only memory (EEPROM), a hard disk drive (HDD), a magnetic disk, a flexible disk, an optical disk, a compact disk, a mini disk, a digital versatile disc (DVD), a drive device thereof, and further any storage medium to be used in the future.

What is described above is a configuration that allows one of hardware and software, etc., to implement the functions of each of the constituent elements of the monitoring control apparatuses 100 to 100E. However, the configuration is not limited to this but a part of the constituent elements of the monitoring control apparatuses 100 to 100E may be implemented by dedicated hardware, and another part of the constituent elements may be implemented by software, etc. For example, the processing circuit 1000 functioning as the dedicated hardware can implement the functions of the part of the constituent elements, and the processing circuit 1000 functioning as the processor 1001 can implement the functions of another part of the constituent elements through reading and executing a program stored in the memory 1002.

As described above, the monitoring control apparatuses 100 to 100E can implement each of the functions by hardware, software, etc., or any combination of these.

### Other Applications

The monitoring control apparatuses 100 to 100E according to Embodiments 1 to 6 described above can be provided in a server computer that configures a cloud environment, so that monitoring data can be fed to the server computer on the cloud through a communication network, and the server computer can identify a causal relationship which can be displayed on a display connected to the communication network.

FIG. 25 is a block diagram illustrating a configuration when the monitoring control apparatuses 100 to 100E are provided in a server computer 300 that configures a cloud environment.

As illustrated in FIG, 25, the server computer 300 includes the monitored item information management DB 10, the monitored-items relevance defining unit 20, the relevant model management DB 30, the monitoring data management DB 40, the causal relationship calculator 50, and the cause identifier 60, Functions of these are identical to those of the constituent elements of the monitoring control apparatuses 100 to 100E.

The monitoring data detected by a plurality of sensors SC disposed in the respective parts of a plant is fed to the server computer 300 through a communication network, and the server computer 300 identifies a causal relationship which is displayed on a display DP connected to the communication network.

A manager of the plant maintains and manages the plant, using the causal relationship displayed on the display DP. The monitoring control apparatuses 100 to 100E provided in the server computer 300 that configures the cloud environment are accessible from anywhere, and the convenience will be improved.

### Embodiment 7

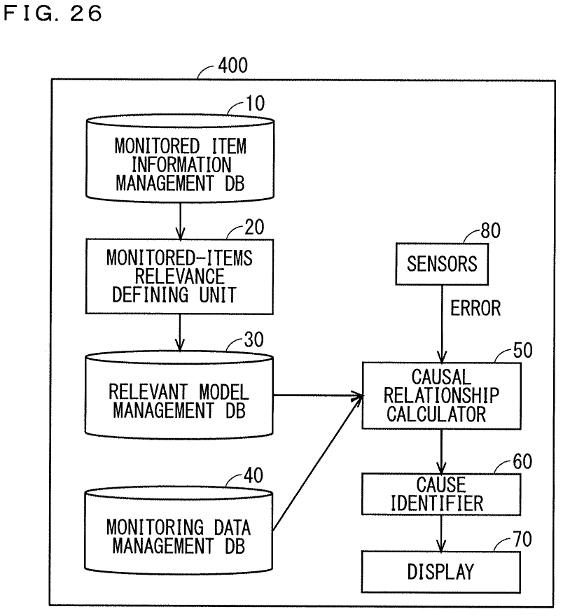

FIG. 26 is a block diagram illustrating a configuration of a monitoring control system 400 according to Embodiment 7 of the present disclosure. As illustrated in FIG. 26, the monitoring control system 400 includes the monitored item information management DB 10, the monitored-items relevance defining unit 20, the relevant model management DB 30, the monitoring data management DB 40, the causal relationship calculator 50, the cause identifier 60, the display 70, and sensors 80.

The monitoring control system 400 includes the plurality of sensors 80 disposed in the respective parts of a plant, in addition to the constituent elements of the monitoring control apparatuses 100 to 100E.

Building the monitoring control system 400 can identify a causal relationship of an error occurrence, and identify a cause of the error occurrence detected by the sensors 80.

While the present disclosure is described in detail, the foregoing description is in all aspects illustrative and does not restrict the disclosure. It is understood that numerous modifications that have not yet been exemplified can be devised without departing from the scope of the present disclosure.

Embodiments of the present disclosure can be freely combined or appropriately modified and omitted within the scope of the disclosure,

1.-3. (canceled)

4. A monitoring control apparatus that monitors a plurality of monitored items that are monitored targets, the monitoring control apparatus comprising:
relevance defining circuitry to define relevance between monitored items in the plurality of monitored items;
a relevant model management database to manage a plurality of relevant models, using relevant monitored items of the plurality of monitored items, the relevant monitored items being defined by the relevance defining circuitry;
a monitoring data management database to manage monitoring data on the plurality of monitored items;
causal relationship calculation circuitry to calculate, when an error occurrence is detected from at least one of the plurality of monitored items, with which monitored item of the plurality of relevant models the error occurrence has a causal relationship, based on the plurality of relevant models managed by the relevant model management database and the monitoring data managed by the monitoring data management database; and
cause identification circuitry to identify a cause of the error occurrence, based on the monitored item with the causal relationship which has been calculated by the causal relationship calculation circuitry,
wherein the causal relationship calculation circuitry calculates the monitored item having the causal relationship with the error occurrence, based on a chronological change in the monitoring data before and after the error occurrence, and
the relevance defining circuitry defines, as the relevance between the monitored items, system relevance between a monitoring control system and an equipment management system.

5. A monitoring control apparatus that monitors a plurality of monitored items that are monitored targets, the monitoring control apparatus comprising:
relevance defining circuitry to define relevance between monitored items in the plurality of monitored items;
a relevant model management database to manage a plurality of relevant models, using relevant monitored items of the plurality of monitored items, the relevant monitored items being defined by the relevance defining circuitry;
a monitoring data management database to manage monitoring data on the plurality of monitored items;
causal relationship calculation circuitry to calculate, when an error occurrence is detected from at least one of the plurality of monitored items, with which monitored item of the plurality of relevant models the error occurrence has a causal relationship, based on the plurality of relevant models managed by the relevant model management database and the monitoring data managed by the monitoring data management database; and
cause identification circuitry to identify a cause of the error occurrence, based on the monitored item with the causal relationship which has been calculated by the causal relationship calculation circuitry,
wherein the causal relationship calculation circuitry calculates the monitored item having the causal relationship with the error occurrence, based on a chronological change in the monitoring data before and after the error occurrence, and
the relevance defining circuitry defines, as the relevance between the monitored items, relevance in information from a different sensor and information from a data source on an identical object.

6. A monitoring control apparatus that monitors a plurality of monitored items that are monitored targets, the monitoring control apparatus comprising:
relevance defining circuitry to define relevance between monitored items in the plurality of monitored items;
a relevant model management database to manage a plurality of relevant models, using relevant monitored items of the plurality of monitored items, the relevant monitored items being defined by the relevance defining circuitry;
a monitoring data management database to manage monitoring data on the plurality of monitored items;
causal relationship calculation circuitry to calculate, when an error occurrence is detected from at least one of the plurality of monitored items, with which monitored item of the plurality of relevant models the error occurrence has a causal relationship, based on the plurality of relevant models managed by the relevant model management database and the monitoring data managed by the monitoring data management database; and
cause identification circuitry to identify a cause of the error occurrence, based on the monitored item with the causal relationship which has been calculated by the causal relationship calculation circuitry,
wherein the causal relationship calculation circuitry calculates the monitored item having the causal relationship with the error occurrence, based on a chronological change in the monitoring data before and after the error occurrence, and
the causal relationship calculation circuitry calculates, as the monitored item having the causal relationship with the error occurrence, a monitored item similar in the chronological change in the monitoring data before and after the error occurrence to the monitored item from which the error occurrence has been detected.

7. The monitoring control apparatus according to claim 6,
wherein the causal relationship calculation circuitry determines, in the monitoring data of the plurality of monitored items managed by the monitoring data management database, a monitored item similar in amount of change between a last detection value and a current detection value of the monitored item from which the error occurrence has been detected to be the monitored item having the causal relationship with the error occurrence.

8.-13. (canceled)
